(19) United States
(12) Patent Application Publication
(10) Pub. No.: US 2005/0252850 A1
(43) Pub. Date: Nov. 17, 2005

(54) Compartmented container

(76) Inventor: Farrag Abdelkarim Ali, Alsafat (KW)

Correspondence Address: DENNISON, SCHULTZ, DOUGHERTY & MACDONALD, 1727 KING STREET, SUITE 105, ALEXANDRIA, VA, 22314, US

(21) Appl. No.: 10/843,454

(22) Filed: May 12, 2004

(51) Int. Cl. B01D 35/02

(52) U.S. Cl. 210/473; 210/282; 220/501; 222/189.06

(57) ABSTRACT

A compartmented container for containing a liquid includes three separate interconnected compartments and a first closeable opening for filling the three compartments with a liquid through the first closeable opening. The compartmented container also includes a second closeable opening disposed in one of the three compartments and which is displaced from the first closeable opening for removing liquid from the three compartments through one of the compartments and a filter for filtering liquid flowing through the one compartment and out of the second closeable opening. The elongated compartments include an upper and lower portion which are joined together in an upper portion thereof and in which the compartment in a lower portion thereof are physically separable from one another. The compartmented container also includes a center compartment and two end compartments and wherein the end compartments are displaceable with respect to one another to thereby form a triangular space therebetween.

### FIELD OF THE INVENTION

The present invention relates to a compartmented container for containing a liquid and more particularly to a compartmented container having three or more elongated curved compartments wherein one of the compartments is displaceable with respect to the other compartments to form a forked claw like structure for hanging from a belt or other object.

### BACKGROUND FOR THE INVENTION

Multi-compartmented containers are well known. For example, a U.S. Patent Publication of Litscher Number 2001/0035430 discloses a storage and dispensing system for multiple liquids. As disclosed therein, a portable waterproof, and refillable storage and dispensing system comprises a multi-tube storing and dispensing portion for liquid toiletries and a carrying or hanging strap.

Other approaches to compartmented containers are disclosed in the U.S. Pat. Nos. 6,450,351 and 6,499,614 of Thompson. As disclosed therein, a multi-compartmented beverage container includes a plurality of compartments and opening means that allows a drinker access to a beverage contained within one compartment while another compartment remains sealed.

The use of a water purifying cartridge for empty polyethylene terephthalate or PET bottles is also known. For example, a U.S. Patent of Kitakazi Number 6,656,350 discloses a water purifying container attached to a PET bottle which is integrally formed with a seat member including a flange member which has substantially the same diameter as an outer shape of a spout. The water purifying cartridge is screwed into an inner portion of a screw cap of a bottle.

Notwithstanding the above, it is presently believed that there may be a relatively large commercial market for an improved multi-compartmented container in accordance with the present invention. There should be a relatively large market for such containers because of an apparent increased use of water bottles by athletes and workers and a need for a water bottle that can be conveniently carried by an individual while jogging, bicycling, working, etc. or conveniently held to a belt or other object without interfering with an individuals movements.

Further, it is presently believed that the multi-compartmented containers disclosed herein can be manufactured and sold at a competitive price, are durable and capable of being placed in various locations such as on a bicycle, ladder, fence or the like. Such containers are also capable of being carried hands free by an individual by placing alternate compartments on opposite sides on an individuals belt, and sized to contain sufficient liquid for an individuals reasonable needs and at the same time can be conveniently carried while playing non-contact sports and/or working. Further, the multi-compartmented containers in accordance with the present invention can be placed on a flat surface without being susceptible to being knocked over and minimize the likelihood of its contents being spilled.

### BRIEF SUMMARY OF THE INVENTION

In essence, the present invention contemplates a container having three or more elongated compartments and means such as a manifold or fluid passage way for interconnecting the three or more compartments. In a preferred embodiment of the invention each of the elongated compartments include an upper and a lower portion and are joined to one another in an upper portion thereof by a manifold or fluid passageway. Each of the lower portions are separated from one another and physically displaceable with respect to one another to form a forked or claw like structure for hanging from a belt, bar or the like.

A first closeable opening such as an orifice surrounded by a threaded neck and closed by a screw cap is provided in a first portion of the container and adapted to fill the three compartments through a single opening. The container also includes means defining a second closeable opening which may be similar to the first closeable opening for dispensing liquid from the three compartments through the second closeable opening. The second closeable opening is disposed in a portion of the container which is displaced from the first closeable opening. For example, in one embodiment of the invention the first closeable opening is in an upper portion of the container and the second closeable opening in a lower portion thereof and constructed and arranged so that the three compartments may be emptied through the second opening. A filter, for filtering liquid flowing through the second opening is disposed in the container as for example adjacent to one of the closeable openings.

The invention will now be described in connection with the following Figures wherein like members are used to designate like elements.

### DESCRIPTION OF THE DRAWINGS

FIG. 1 is a perspective view of a compartmented container in accordance with a first embodiment of the invention;

FIG. 2 is a top view of the compartmented container of FIG. 1 with a lower portion of the compartments displaced from one another;

FIG. 3 is a side cross sectional view of a compartmented container shown in FIGS. 1 and 2;

FIG. 4 is a perspective view of a second embodiment of the invention;

FIG. 5 is a top view of a compartmented container according to a further embodiment of the invention; and

FIG. 6 is a cross-sectional view of a container in accordance with the further embodiment of the invention.

### DESCRIPTION OF THE PREFERRED EMBODIMENTS OF THE INVENTION

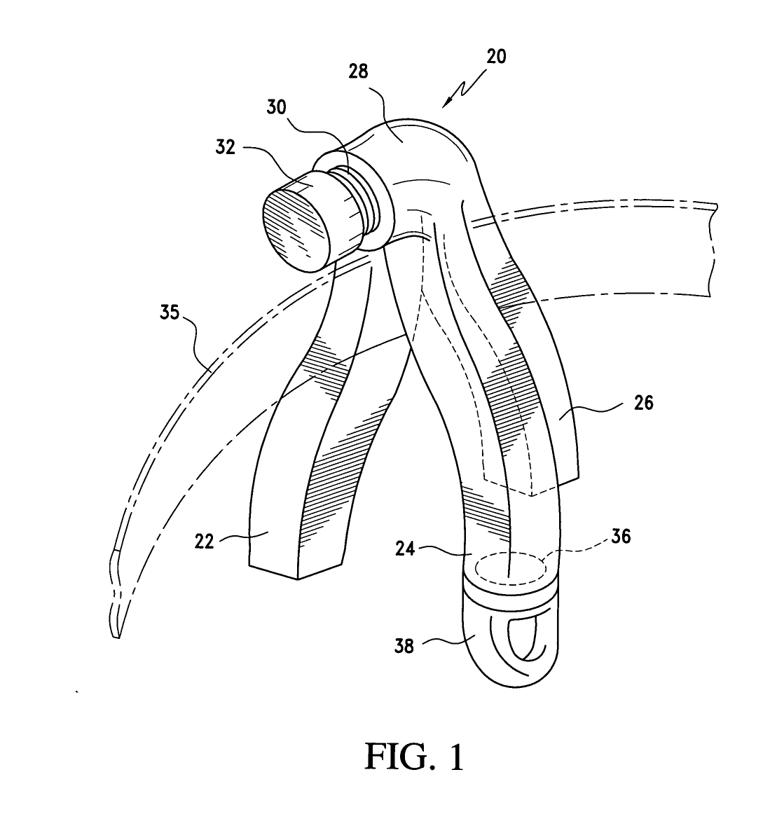

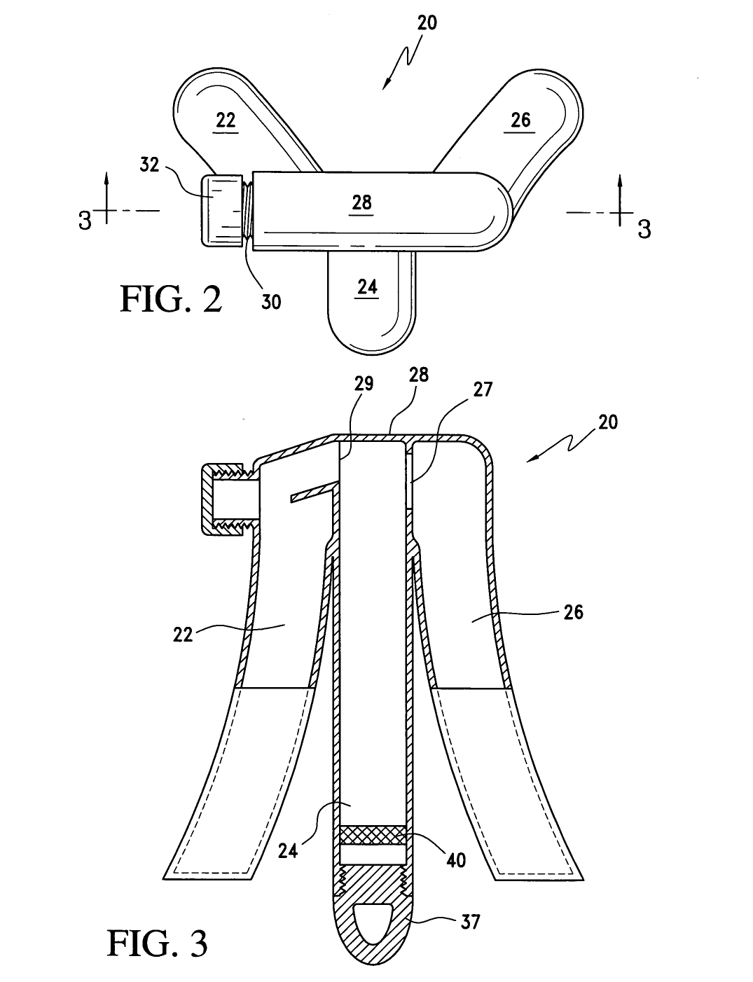

As illustrated in FIGS. 1-3, a multi-compartmented container 20 in accordance with a first embodiment of the invention includes three elongated chambers or compartments 22, 24 and 26. The compartments 22, 24 and 26 preferably have a generally curved shape with the compartment 24 referred to hereinafter as the central compartment displaced between the compartments 22 and 26. The compartments 22 and 26 may hereinafter be referred to as end compartments. In essence, the shape of the container 20 with the three compartments 22, 24 and 26 resembles a small bunch of bananas. In a preferred embodiment of the invention the container 20 is made of a semi-rigid or somewhat flexible plastic such as polyethylene or polyethyleneterephthalate or similar material and has a thickness that allows displacement of the lower portion of the compartments.

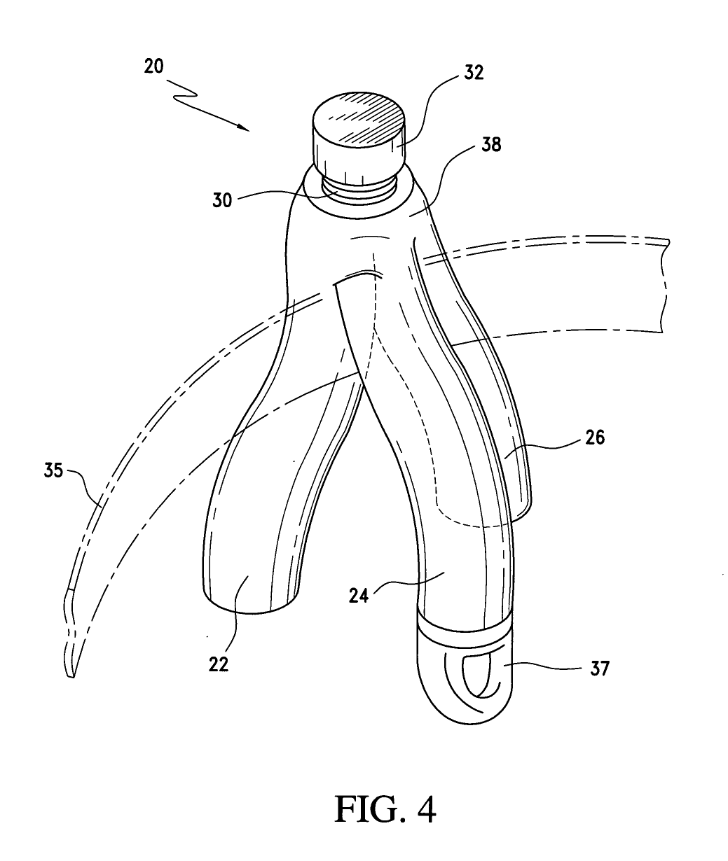

The compartments 22, 24 and 26 are interconnected by fluid passage means or manifold 28. The manifold 28 also includes a closeable opening having a threaded neck portion 30 and threaded cover 32 for opening and closing the container 20. As illustrated, the threaded neck portion is generally perpendicular to the three compartments, but may be parallel thereto as illustrated in FIG. 4. The threaded neck portion may also be rotated 90° to face away from an individual when the container 20 is hung on an individuals belt 35 or may be connected through a flexible coupling.

As illustrated in FIGS. 1-3, the container 20 includes a second internally threaded closeable opening 36 (see FIG. 3) in a lower or bottom portion of the central compartment 24. The closeable opening 36 is closeable by means of an externally threaded closer 37. A filter 40 such as a carbon filter is disposed in a lower portion of the central compartment 24. The filter 40 may be positioned and held in place by any conventional means such as a shoulder and flange (not shown) and may be replaceable. For example, the filter 40 may be adjacent to and replaced through the opening 36. It is also contemplated that a filter may be provided adjacent to the opening in the manifold 28.

However, in a presently preferred embodiment of the invention, the filter 40 is positioned in a lower portion of the compartment 24 from which an individual will consume the contents of the container. The filter is placed in the lower portion of compartment 24, to avoid the possibility of merely removing the chlorine from tap water when the container is filled through the manifold 28. The concern is that removing only the chlorine from tap water would allow bacterial buildup on the surface of the liquid in the container. Further, by placing the filter in the central compartment 24 near an opening therein, allows for the use of a relatively dense or thick filter to be used. In this way, the container can be filled relatively quickly through the manifold 28.

As shown in FIG. 3, the manifold 28 includes openings 27 and 29 which form a fluid passage means. For example, the opening 27 allows fluid to flow between the compartments 24 and 26 while the opening 29 allows liquid to flow between the compartments 22 and 24. In this way, liquid which enters through the closeable opening in the manifold 28 fills all three compartments. The openings also allow liquid from all three compartments to be removed from the container 20 through the second opening.

A second embodiment of the invention is shown in FIG. 4 wherein a closeable opening in the manifold 38 includes a threaded neck portion 30 and closure means or cap 32 in the same manner as described in connection with the first embodiment of the invention. However, in a second embodiment of the invention, the opening for filling the container 20 is generally parallel with the compartments 22, 24 and 26 and is believed to facilitate filling of the container.

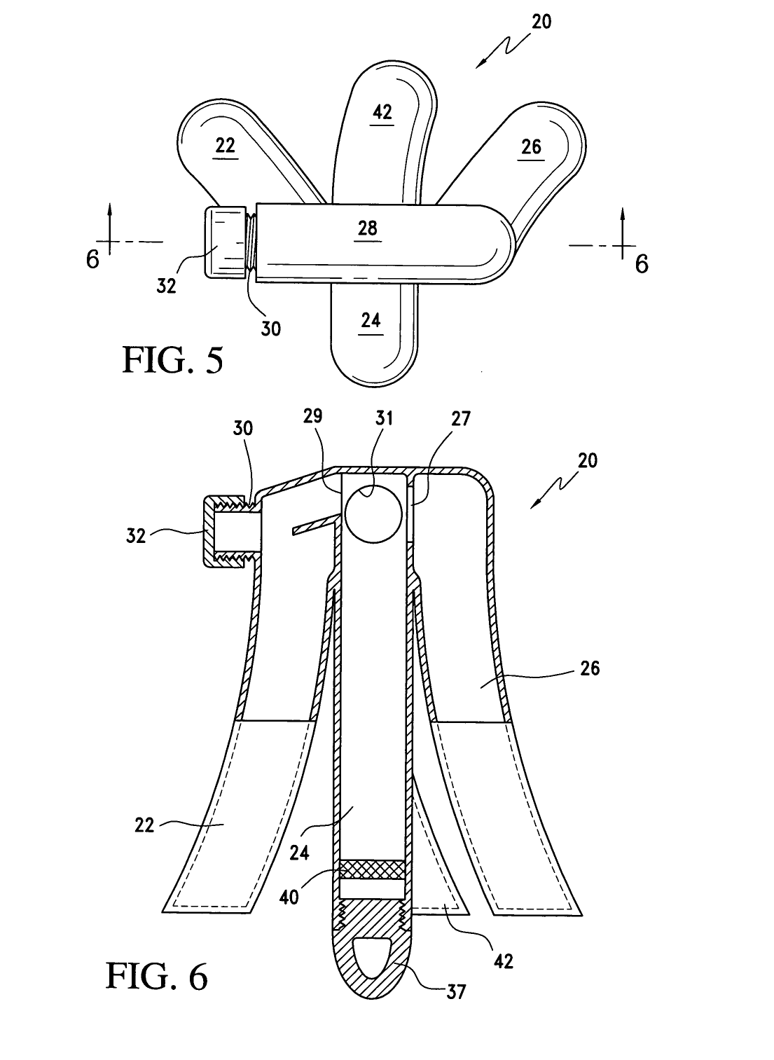

A third embodiment of the invention is illustrated in FIGS. 5 and 6. As shown therein, the container 20 also includes a fourth elongated chamber 42 which is connected to the compartments 22, 24 and 26 through the manifold 28 which includes an opening 31 for the flow of liquid between the compartments.

The aforementioned embodiments are preferably made of polyethylene, teraphthalate (PET) or other suitable plastic material that provides durability and sufficient flexibility to allow a lower portion of one of the compartments to be displaced from a lower portion of the other compartments. In this way, the container 20 can be hung over the rung of a ladder, handlebar of a bicycle or other objects. The container 20 ma also be made by conventional molding techniques as will be well understood by persons of ordinary skill in the art.

While the invention has been described in connection with its preferred embodiments, it should be recognized that changes and modifications may be made therein without departing from the scope of the appended claims.

1. A compartmented container for containing a liquid comprising means defining three separate compartments and means interconnecting said three compartments, means defining a first closeable opening for filling said three compartments with a liquid and means defining a second closeable opening disposed in one of said three compartments displaced from said first closeable opening for removing liquid from said three compartments through said one of said compartments and a filter for filtering liquid flowing through said one of said compartments and out of said second closeable opening.

2. A compartmented container for containing a liquid according to claim 1 in which each of said elongated compartments include an upper and lower portion and in which said three compartments are joined together in an upper portion thereof and in which said lower portion thereof are physically separable from one another.

3. A compartmented container for containing a liquid according to claim 2 in which each of said closeable openings includes a threaded neck and a threaded cap.

4. A compartmented container for containing a liquid according to claim 2 in which said means interconnecting said three compartments includes a flexible portion for allowing a portion of each of said three compartments to be displaced with respect to one another.

5. A compartmented container for containing a liquid in accordance with claim 4 which includes a central compartment and two end compartments and in which said end compartments are displaceable with respect to one another to thereby form a triangular space therebetween.

6. A compartmented container for containing a liquid in accordance with claim 5 in which said container is made of a thermo plastic material.

7. A compartmented container for containing a liquid according to claim 6 in which said second opening and said filter are disposed in said lower portion of said central compartment.

8. A compartmented container for containing a liquid according to claim 7 in which said filter is a carbon filter.

9. A compartmented container for containing a liquid according to claim 5 in which said separated compartments form a curved fork like structure.

10. A compartmented container for containing a liquid wherein said curved elongated compartments are generally parallel when in a first or normal position and wherein one of said elongated compartments is displaceable into a non-parallel position for hanging said container over an object.

11. A compartmented container for containing a consumable liquid comprising three elongated curved compartments and fluid passage means interconnecting said compartments, means including a first closeable opening for filling said three compartments through said first closeable opening and a second closeable opening for emptying said three compartments through said second closeable opening and a filter for filtering a liquid in said compartments disposed between said first and said second closeable openings and wherein one of said compartments is partially displaceable with respect to the other of said compartments to form a forked claw-like structure for hanging from a belt or other object.

12. A compartmented container according to claim 11 in which said container is made of a flexible thermo plastic material.

13. A compartmented container according to claim 12 in which said thermo plastic material is polyethylene terephthalate.

14. A compartmented container for containing a liquid in accordance with claim 9 in which two of said elongated curved compartments overlap a third compartment.

15. A compartmented container according to claim 3 in which the curved elongated compartments are dimensioned and configured so that two of said compartments overlap one of said compartments so that one of said compartments are forced between said two of said compartments whereby the container is held in place about an object.
